(19) United States
(12) Patent Application Publication
(10) Pub. No.: US 2026/0269092 A1
(43) Pub. Date: Sep. 10, 2026

(54) HEAT EXCHANGER BELLOWS SEAL ASSEMBLY AND METHODS OF USE

(71) Applicant: Natura Resources LLC, Abilene, TX (US)

(72) Inventors: Alton Reich, Abilene, TX (US); Thomas Provencher, Abilene, TX (US)

(21) Appl. No.: 19/557,361

(22) Filed: Mar. 5, 2026

Related U.S. Application Data
(60) Provisional application No. 63/767,343, filed on Mar. 5, 2025.

(51) Int. Cl. G21C 13/028; G21C 3/54; G21C 13/04

(52) U.S. Cl. CPC G21C 13/028; G21C 3/54; G21C 13/04

(57) ABSTRACT

Modern molten salt reactors are configured with all salt bearing equipment within a thermal insulation layer defining a thermal region to ensure the equipment is at a sufficient temperature to maintain a molten phase of the salt. While this allows all salt bearing equipment to be collectively elevated to operational temperature, any components breaching the thermal region may cause undue stress on components affixed thereto. A bellows seal assembly may be employed on such breaching components to accommodate thermal growth of the thermal region. The bellows seal assembly may include attachment means to affix the breaching component to an inner and outer layer and a flexible member to accommodate movement caused by thermal growth.

### CROSS REFERENCE TO RELATED APPLICATIONS

This application relates and claims priority to U.S. Provisional Application No. 63/767,343, filed Mar. 5, 2025, and entitled “HEAT EXCHANGER BELLOWS SEAL ASSEMBLY AND METHODS OF USE,” which is hereby incorporated by reference in its entirety.

### TECHNICAL FIELD

The described examples relate generally to systems, devices, and techniques for a bellows seal assembly about a primary heat exchanger.

### BACKGROUND

Molten salt reactors (MSR) maintain fuel salt at an elevated temperature to keep the salt in a molten phase. Previous iterations of MSRs, such as the Molten Salt Reactor Experiment as Oak Ridge National Laboratory, utilized heaters attached to various insulated components and piping to keep them at an elevated temperature sufficient to melt the fuel salt. Modern MSR systems may employ a different approach for ensuring the fuel salt stays molten. Such approaches may involve forming an insulated oven within the reactor enclosure heated to the requisite temperature for operating the MSR system with all salt bearing components being contained within the oven. In many cases, the insulated oven may be entirely encircled by a radiation shielding layer of the reactor enclosure to prevent harm to its environment. However, while the insulated oven may expand as temperature increases, the reactor enclosure does not reach such operational temperatures and does not expand or very minimally expands. This inconsistency can cause strain on components that cross the temperature boundary between these two layers. As such, there is a need for systems, devices, and techniques to accommodate component stress caused by thermal growth within the reactor enclosure.

### SUMMARY

In one example, a system is disclosed. The system includes a reactor enclosure including a thermal insulation layer and an outer layer. The thermal insulation layer is contained within the outer layer and defining a thermal region. The outer layer defines a pressure boundary. The system further includes a molten salt reactor vessel including a reactor core configured to facilitate fission reaction disposed within the thermal region. The system further includes a primary heat exchanger comprising a shell defining a shell volume and a coolant tube assembly comprising an internal coolant pipe section fluidly coupled to an external coolant pipe section. The shell is disposed within the thermal region. The tube assembly is disposed, relative to the shell, with the internal coolant pipe section within the shell volume and the external coolant pipe section extending therefrom, exterior to the thermal insulation region and through the pressure boundary. The system further includes a bellows seal assembly disposed about the external coolant pipe section of the primary heat exchanger and connected to each of the thermal insulation layer and the outer layer. The bellows seal is configured to accommodate thermal expansion of the thermal insulation layer by compressing toward the outer layer while maintaining the connection between the thermal insulation layer and the outer layer.

In another example, the bellows seal is configured to maintain the pressure boundary upon compression.

In another example, the bellows seal is configured to allow the shell to translate with the thermal insulation layer upon thermal expansion via compression of a flexible element.

In another example, the bellows seal includes a first flange and a second flange. The first flange anchors the shell to the thermal insulation layer. The first flange also connects the flexible element to the thermal insulation layer. The second flange connects the flexible element to the outer layer.

In another example, the shell volume is fluidically coupled to a drain tank and the molten salt reactor vessel. The shell volume is configured to receive an elevated-temperature flow of molten salt from a fuel salt inlet, and upon heat removal therein, deliver a reduced-temperature flow of molten salt from a fuel salt outlet to the drain tank or the molten salt reactor vessel.

In another example, the fuel salt inlet is disposed along a topmost surface of the shell. The fuel salt outlet is disposed along a bottommost surface. The topmost and bottommost surface are angularly offset relative to a horizontal axis of the system. The angular offset causes gravitational draining of the fuel salt disposed within the shell volume out of the fuel salt outlet.

In another example, the primary heat exchanger further comprises a transition region comprising a first compartment and a second compartment fluidly connecting and interposed between the external coolant pipe section to the internal coolant pipe section. The first compartment defines a first flow path between a first external coolant pipe of the external coolant pipe sections and an entrance of a first internal coolant loop of the internal coolant pipe sections. The second compartment defines a second flow path between a return of the first internal coolant loop of the internal coolant pipe sections and a second external coolant pipe of the external coolant pipe sections.

In another example, the transition region comprises a partition separating the first and second compartment from one another.

In another example, the partition defines at least one weeping passage having a diameter smaller than a diameter of each of a plurality of passages of a tube sheet and fluidly coupling the first compartment and the second compartment.

In another example, the bellows seal assembly defines a passage for the external coolant pipe section; and wherein the passage comprises ambient air.

In another example, the thermal insulation layer is arranged within the reactor enclosure at an inward offset from the outer layer about the periphery of the thermal insulation layer.

In another example, the thermal region is about 600° C.; and wherein the periphery of the thermal insulation layer is about 100° C.

In yet another example, a system is disclosed. The system includes a primary heat exchanger including a shell defining a shell volume and a tube assembly comprising an internal coolant pipe section fluidly coupled to an external coolant pipe section. The shell is fluidly coupled to a fuel salt loop of a nuclear reactor system. The system further includes a bellows seal assembly disposed about the external coolant pipe section such that a coolant inlet and a coolant outlet are surrounded by the bellows seal. The bellows seal assembly is at least partially interposed between a thermal insulation layer and an outer layer of a reactor enclosure of the nuclear reactor system. The insulation layer is disposed within the outer layer. The insulation layer defines a thermal region. The outer layer defines a pressure boundary. The bellows seal assembly operable is to accommodate thermal expansion of the thermal insulation layer via compression of the bellows seal thereby enabling horizontal translation of the primary heat exchanger.

In another example, the bellows seal is operable to maintain the pressure boundary upon horizontal translation of the primary heat exchanger.

In another example, the bellows seal assembly includes a first flange anchoring the primary heat exchanger to the thermal insulation layer and a flexible element to the thermal insulation layer. The bellows seal assembly includes a second flange anchoring the flexible element to the outer layer.

In another example, the first flange, the second flange, and the flexible element are collectively operable, upon horizontal translation of the primary heat exchanger, to cause the shell of the primary heat exchanger to translate relative to the outer layer and remain fixed relative to the thermal insulation layer.

In another example, the primary heat exchanger is fluidly coupled, via the fuel salt loop, to a drain tank or a reactor vessel of the nuclear reactor system. The shell volume is configured to receive an elevated-temperature flow of molten salt from a fuel salt inlet, and upon heat removal therein, deliver a reduced-temperature flow of molten salt from a fuel salt outlet to the drain tank or the reactor vessel.

In another example, the fuel salt inlet is disposed along a topmost surface of the shell. The fuel salt outlet is disposed along a bottommost surface of the shell. The topmost and bottommost surfaces are angularly offset relative to a horizontal axis of the system. The angular offset causes gravitational draining of the fuel salt disposed within the shell volume out of the fuel salt outlet.

In another example, the primary heat exchanger further includes a transition region comprising a first compartment and a second compartment. The first compartment defines a first flow path between a first external coolant pipe of the external coolant pipe section and an entrance of a first internal coolant loop of the internal coolant pipe section. The second compartment defines a second flow path between a return of the first internal coolant loop of the internal coolant pipe section and a second external coolant pipe of the external coolant pipe section. The transition region comprises a partition separating the first and second compartment from one another. The partition defines at least one weeping passage fluidly coupling the first compartment and the second compartment.

In yet another example, a method of operating a bellows seal assembly of a primary heat exchanger is disclosed. The method includes operating a molten salt reactor system enclosed within a reactor enclosure comprising a thermal insulation layer and an outer layer thereby causing a temperature of a fuel salt to increase. The molten salt reactor system includes a molten salt loop coupled to a primary heat exchanger. The primary heat exchanger comprises a shell affixed to the thermal insulation layer fluidly coupled to external secondary salt piping affixed to the outer layer. The bellows seal assembly is disposed about the external secondary salt piping. The method further includes circulating the fuel salt through the molten salt loop to the primary heat exchanger. The method further includes extracting heat from the fuel salt to a secondary salt by the primary heat exchanger. The method further includes permitting expansion of the thermal insulation layer upon operation of the molten salt reactor system while maintaining connection between the shell and the thermal insulation layer via compression of the bellows seal assembly.

### BRIEF DESCRIPTION OF THE DRAWINGS

FIG. 1 illustrates an example molten salt reactor system.

FIG. 2 illustrates an example molten salt reactor system and reactor enclosure equipped with a bellows seal assembly.

FIG. 3 illustrates an example bellows seal assembly.

FIG. 4 illustrates a fluid flow diagram of fluid through an example primary heat exchanger.

FIG. 5 illustrates an example implementation of the bellows seal assembly in a reactor enclosure.

FIG. 6A illustrates a side view of the example implementation of the bellows seal assembly of FIG. 5.

FIG. 6B illustrates a focused view of the example implementation of the bellows seal assembly taken along the 6B-6B line of FIG. 6A.

FIG. 7 illustrates a flow diagram of an example method of operating a bellows seal assembly of a primary heat exchanger.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes example systems, methods, and apparatuses that embody various elements of the present disclosure. However, it should be understood that the described disclosure may be practiced in a variety of forms in addition to those described herein.

The following disclosure relates generally to a bellows seal assembly for a primary heat exchanger of a molten salt reactor (MSR) system for accommodating thermal expansion. MSR systems require salt-bearing components (e.g., reactor core, reactor access vessel, primary heat exchanger, piping therebetween, etc.) to be at an elevated temperature to ensure the fuel salt remains in a liquid or molten phase. Modern MSR systems, such as the various example MSR systems disclosed herein, may utilize a thermal insulation layer fully encompassing salt-bearing components, such that the salt-bearing components are within a thermally hot region (i.e., about 600° C.) or “thermal region” defined by the thermal insulation layer. This thermal insulation layer may be further encompassed by a radiation shielding layer, with a gap therebetween, collectively forming a reactor enclosure. This enables the salt-bearing components to be at the requisite temperature without requiring each component to be individually heated and insulated. However, as the reactor system reaches operational temperature (e.g., about 600° C.), the thermal insulation layer is expected to expand while the radiation shielding layer is not expected to expand or may expand only minimally. Thus, any reactor component that crosses the thermal insulation and radiation shielding layers will be faced with the inconsistency of being bound to both an expanding layer and a relatively stagnant layer, which may cause excessive pipe stress causing damage to the system.

Such a reactor component crossing these boundaries may be the primary heat exchanger. By its nature of facilitating heat transfer, the primary heat exchanger must at least partially receive fuel salt (i.e., be salt-bearing) and consequently must be disposed within the thermal region but must interface with a coolant (e.g., a secondary salt such as 2LiF—BeF₂) to facilitate heat transfer. Furthermore, primary heat exchanger may require maintenance of, for example, the tube sheet. To facilitate access to the tube sheet, it must be accessible from outside the reactor enclosure and preferably not in the thermal region. The primary heat exchanger must be fluidly connected to an external heat removal system, any such piping connections will be outside the thermal region. This may cause piping connections to experience undue stress upon thermal expansion and movement of the primary heat exchanger. Thus, while it is advantageous to provide a thermal region for salt bearing components, it may also be desirable to include a primary heat exchanger that at least partially crosses this boundary. This causes an inconsistency in the movement of the thermal insulation layer and the radiation shielding layer that can cause damage to the system.

In certain embodiments, the present invention contemplates a two pass U-tube type heat exchanger with the fuel salt circulated through a shell and a coolant (e.g., a secondary salt) circulated through the U-tubes within the shell. The primary heat exchanger may be disposed within the thermal region but extend outside the reactor enclosure through the thermal insulation layer and outer layer. The primary heat exchanger extends through the thermal insulation layer and outer layer. The thermal insulation layer is anticipated to expand due to thermal expansion while the outer layer is anticipated to not expand or expand only minimally, an inconsistency occurs in that as the insulation layer expands outward and the outer layer remains relatively fixed stress is caused on both the primary heat exchanger and the various piping connections affixed thereto. Additionally, the pressure boundary defined by the outer layer is maintained despite penetration of these layers by the primary heat exchanger.

To mitigate these and other challenges, the heat exchanger bellows seal assembly of the present disclosure may be disposed about the primary heat exchanger of an MSR system. The heat exchanger bellows seal assembly facilitates connection of the primary heat exchanger to the thermal insulation layer and is itself connected to the outer layer. The bellow seal assembly is operable to allow horizontal translation of the primary heat exchanger without causing undue stress to piping components, enabling access to the tube sheet, and maintaining the pressure boundary of the outer layer. Such bellows seal assembly may encompass portions of the primary heat exchanger that extend through the thermal insulation layer and radiation shielding layer. The bellows seal assembly is configured to compress as the thermal insulation layer's diameter expands and as the primary heat exchanger to translate horizontally toward the outer layer. The bellows seal assembly may also be configured to maintain the pressure boundary of the outer layer by including airtight attachment means. This configuration further enables access to the tube sheet during maintenance periods without having to drastically disassemble the MSR system.

To facilitate the foregoing, the primary heat exchanger may be equipped with a bellows seal assembly comprising a first flange, a flexible element, and a second flange. The first flange may be generally configured to anchor the shell of the primary heat exchanger and the flexible element to the thermal insulation layer. The flexible element may be interposed between the first flange and the second flange and configured to compress upon thermal expansion of the thermal insulation layer. The second flange may be generally configured to anchor the flexible element to the outer layer and encompasses external coolant inlet and outlet pipes of the primary heat exchanger. Collectively, these components allow the primary heat exchanger to translate as the thermal insulation layer expands as the MSR system is heated. Additionally, the bellow seal assembly allows such translation without causing undue stress on the various piping connections of the primary heat exchanger. The flexible element may compress to accommodate such expansion and translation.

In preferred embodiments, the present assembly is not deployed on a piping system, but rather as a flexible, pressure retaining attachment between a reactor enclosure and a component that protrudes through the wall of that enclosure. Such a protruding component may be the primary heat exchanger of the reactor system. Where the shell of the primary heat exchanger is partially positioned both in a high temperature thermal region (e.g., the thermal oven) and an only slightly above room temperature pressure retaining outer layer, thermal expansion is likely inconsistent across the boundary therebetween, which may cause damage to the heat exchanger shell. For example, if the primary heat exchanger were to be firmly attached to the reactor enclosure, piping on the thermally hot side will experience significant nozzle loads and may fail due to high stresses. By hard mounting the primary heat exchanger to the thermal insulation layer, the fuel salt piping nozzle (i.e., inlets and outlets) loads are reduced such that the heat exchanger is able to move relative to the reactor enclosure thereby eliminating or at least mitigating damage to the heat exchanger. The bellows seal assembly of the present disclosure is operable to deflect sufficiently to allow thermal growth without causing damage to internal components.

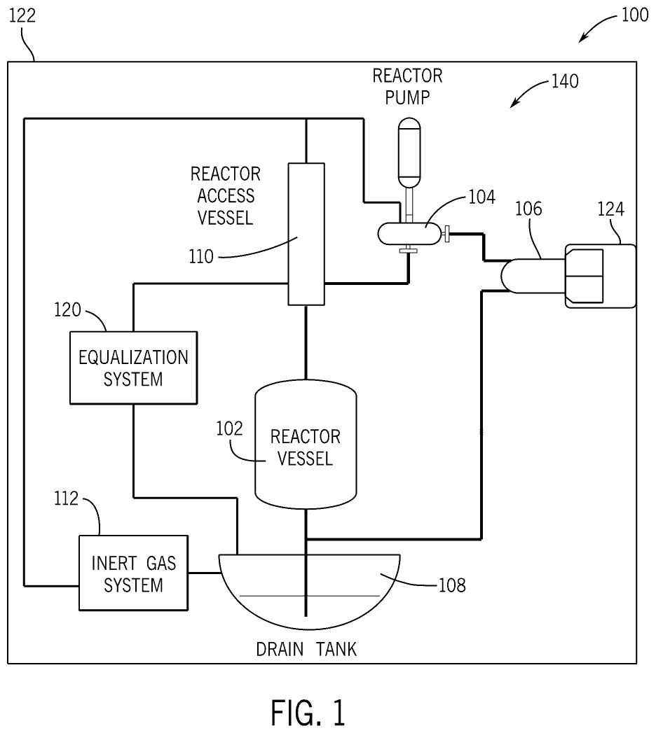

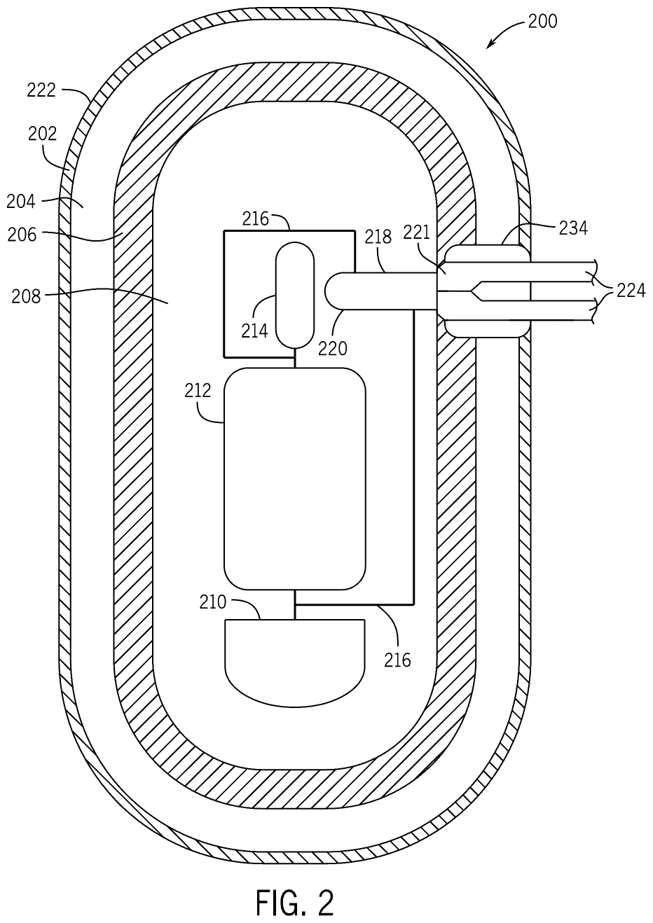

Turning now to the Drawings, FIG. 1 illustrates a schematic representation of an example molten salt reactor (MSR) system 100 to which a bellows seal assembly 124 may be employed, as depicted schematically in FIG. 1, and as described in greater detail herein at FIGS. 2-3, 5-6B (e.g., the bellows seal assembly 234, 300, 500). In various embodiments, a MSR system 100 utilizes fuel salt enriched with uranium (e.g., high-assay low-enriched uranium) to create thermal power via nuclear fission reactions. In at least one embodiment, the composition of the fuel salt may be LiF—BeF₂—UF₄, though other compositions of fuel salts may be utilized as fuel salts within the reactor system 100. The fuel salt within the system 100 is heated to high temperatures (about 600-700° C.) and melts as the system 100 is heated. In several embodiments, the MSR system 100 is at least partially enclosed by a reactor enclosure 122. The reactor enclosure 122 may generally comprise a thermal insulation layer and an outer radiation shielding layer. In several embodiments, the reactor enclosure 122 includes a thermal insulation layer defining a thermal region therein operable to maintain a high temperature necessary to maintain a molten phase of the fuel salt (i.e., 600-700° C.). In various embodiments, all or substantially all salt-bearing components (i.e., those containing fuel salt, or making contact with fuel salt) are disposed within the thermal region. The insulating layer effectively functions as an oven by insulating the heat produced via fission reaction (or by external heaters) within the reactor vessel 102 to maintain a temperature of the MSR system 100. In several embodiments, the molten salt reactor system 100 includes a reactor vessel 102 where the nuclear reactions occur within the molten fuel salt, a fuel salt pump 104 that pumps the molten fuel salt to a primary heat exchanger 106, such that the molten fuel salt re-enters the reactor vessel after flowing through the heat exchanger and piping in between each component. The piping between each component facilitates circulation of the molten salt and may be collectively referred to as the molten salt loop. The MSR system 100 may also include additional components, such as, but not limited to, drain tank 108 and reactor access vessel 110. The drain tank 108 may be configured to store the fuel salt once the fuel salt is in the reactor system 100 but in a subcritical state and also acts as storage for the fuel salt if power is lost in the system 100. The reactor access vessel 110 may be configured to allow for introduction of small pellets of uranium fluoride (UF₄) to the system 100 as necessary to bring the reactor to a critical state and compensate for depletion of fissile material. In several embodiments, the primary heat exchanger 106 breaches the thermal insulation and/or radiation shielding layer.

In several examples, the molten salt reactor system 100 may include an inert gas system 112 to provide inert gas (e.g., nitrogen) to a head space of the drain tank 108, among other functions. The inert gas system 112 may further relieve inert gas from the headspace of the drain tank 108 as needed. The inert gas system 112 is therefore operable to maintain pressurized inert gas in the headspace of the drain tank 108 that is sufficient to substantially prevent the flow of molten fuel salt into the drain tank during normal operations. In some embodiments, the inert gas system 112 is operable to maintain a pressure below atmospheric pressure within the headspace. For example, with the headspace of the drain tank 108 pressurized by the inert gas system 112, the molten salt may generally circulate between the reactor vessel 102 and the primary heat exchanger 106 without substantially draining into the drain tank 108. In some cases, the inert gas system 112 may be configured to supply inert gas to the headspace of various other components of the molten salt reactor system 100, such as to the headspace of the reactor access vessel 110, to the seal of reactor pump 104, among other components.

The molten salt reactor system 100 may further include an equalization system 120 that is operable to equalize the pressure between the headspace of the drain tank 108 and the reactor vessel 102 upon the occurrence of a shutdown event. For example, during normal operation, a pressure differential exists between the headspace of the drain tank 108 and the reactor vessel 102. Such pressure differential prevents or impedes the draining of the fuel salt into the drain tank 108. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event. Upon the occurrence of a shutdown event, the inert gas system 112 may cease providing inert gas to the head space of the drain tank 108, and other components to which the system 112 supplies inert gas. Consequently, this causes the pressure of the headspace of the drain tank 108 to decrease, which causes the fuel salt to gravitationally drain to the drain tank 108, which may be disposed at a lowermost section of the MSR system 100. Advantageously, in the event of a loss-of-power emergency situation, or other malfunction, the inert gas system 112 enables “walk-away safety” in that the system ceases fission reaction (i.e., fuel salt drains into the drain tank 108 rather than circulating to the reactor vessel 102) passively.

The MSR system 100 may further include a bellows seal assembly 124 at least partially disposed with the reactor enclosure 122. The bellows seal assembly 124 may be disposed about a portion of the primary heat exchanger 106 and anchor the primary heat exchanger to the thermal insulation layer and be further anchored itself to the outer layer of the reactor enclosure 122. The bellows seal assembly 124 may be generally operable to accommodate thermal expansion of the thermal insulation layer by including a flexible element configured to compress as the insulation layer expands. The bellows seal assembly 124 is further operable to allow the primary heat exchanger 106 to translate relative to the outer layer but remain fixed relative to the thermal insulation layer (i.e., translate with the expansion of the thermal insulation layer). The bellows seal assembly may be further operable to maintain the pressure boundary of the outer layer by including airtight attachment means. In several embodiments, the bellow seal assembly 124 includes a first attachment means to connect the primary heat exchanger 106 to the thermal insulation layer and attach the flexible element to the thermal insulation layer. The bellow seal assembly 124 may include a second attachment means connecting the flexible element to the thermal insulation layer.

It will be appreciated that the systems, devices, and methods related to the bellows seal assembly may be used to accommodate nondamaging translation of various components disposed within the thermal region but extending outside the thermal region. One of ordinary skill in the art will appreciate that the bellows seal assembly of the present disclosure may be employed on other components other than the primary heat exchanger.

FIG. 2 illustrates an example molten salt reactor system 200 and reactor enclosure 222 equipped with a bellows seal assembly 234. The reactor system 200, reactor enclosure 222, bellow seal assembly 234 may be substantially analogous to the reactor system 100, reactor enclose 122, and bellows seal assembly 123, etc. shown and described in relation to FIG. 1. Notwithstanding, FIG. 2 shows the reactor system 200 and additionally illustrates a thermal insulation layer 206, a gap 204, an outer radiation shielding layer 202, and external coolant external coolant tube section 224. The bellows seal assembly 234 may be configured to enable horizontal translation of a primary heat exchanger 218 during thermal expansion of a thermal insulation layer 206. The bellows seal assembly 234 may be generally disposed between the thermal insulation layer 206 and the radiation shielding layer 202. While FIG. 2 may illustrate these layers of being a certain width and size, one of ordinary skill in the art will appreciate that these layers (and all components depicted in FIG. 2) may not be drawn to scale and may be of varying size and thickness based on the specific design.

The reactor enclosure 222 may be a vessel housing the components of an MSR system 200. In several embodiments, the reactor enclosure 222 is a cylindrical stainless-steel vessel. The reactor enclosure 222 may include an outer layer or radiation shielding layer 202. Radiation shielding layer 202 may be generally operable to shield an environment exterior to the reactor enclosure 222 from radiation given off from nuclear fission occurring within the MSR system 200. The radiation shielding layer 202 may be composed of a radiation shielding or absorbing material known in the art, for example lead, tungsten, stainless steel, concrete, heavy metal compositions, or any combination thereof. The radiation shielding layer 202 may encompass a thermal insulation layer 206 with a gap 204 interposed there between. The thermal insulation layer 206 may encompass all or substantially all salt-bearing components of the MSR system 200, for example, a drain tank 210, a reactor vessel 212, a reactor access vessel 214, the primary heat exchanger 206, and piping 216 therebetween.

The MSR system 200 may include a primary heat exchanger 218 and bellows seal assembly 234. As previously discussed, the primary heat exchanger 218 may breach the thermal insulation 206 and/or radiation shielding layer 202. The primary heat exchanger 218 may include a shell 220 disposed within the thermal region 208, a water box 221 defining a transitional region, and an external coolant tube section 224. In several embodiments, the water box 221 is disposed partially within the thermal region 208 and partially within the thermal insulation layer 206. In other embodiments, the water box 221 is disposed completely within the gap 204 or completely within the thermal insulation layer 206. In several embodiments, the external coolant tube section 224 is fluidly connected to the water box 221 and extends out of the thermal insulation layer 206 and outer layer 202. External coolant tubes of the external coolant tube section 224 may be fluidly connected to a heat removal system. The shell 220 of the primary heat exchanger 218 may be fluidly connected via piping 216 to the drain tank 210, reactor vessel 212, and reactor access vessel 214.

As discussed, all salt-bearing components must be maintained at an elevated temperature (e.g., about 600° C.) so the fuel salt remains in a molten phase. Such components may be initially heated using external heaters. The thermal insulation layer 206 is operable to maintain such a temperature and defines a thermal region 208 therein. For clarity, the thermal region 208 refers to the space internal to the thermal insulation layer. The salt-bearing components (e.g., a drain tank 210, a reactor vessel 212, a reactor access vessel 214, the primary heat exchanger 206, and piping 216) may be disposed within the thermal region 208.

Due to the increase in temperature, the thermal insulation layer 206 is anticipated to expand radially outwards as the MSR system 200 reaches operational temperature (e.g., about 600° C.). The gap 204 is configured to accommodate such thermal expansion by providing space for the thermal insulation layer 206 to occupy. However, the thermal insulation layer 206, via its insulating properties, prevents the outer layer 202 and consequently the exterior of the reactor vessel 222 from increasing in temperature. The outer layer 202 may only reach temperatures of about 100° C. and consequently will not or will only minimally expand. The gap 204 may be filled with an inert gas, or other gas composition and may be generally operable to provide insulating properties.

The shell 220 of the primary heat exchanger 218 is a salt-bearing component as it receives heated fuel salt from the reactor vessel 212. In several embodiments, the primary heat exchanger 218 is positioned such that the entire shell 220 is within the thermal insulation layer 206. Advantageously, this allows any potential leaks of fuel salt to be captured by the thermal insulation layer 206. Additionally, the piping connections 216 to the primary heat exchanger 218 must be exposed to minimal to no thermal growth-related stress as the piping 216 material (e.g., stainless steel) may not be able to accommodate such stress, which is avoided by disposing the shell within the thermal region 208. In several embodiments, at least a portion of the primary heat exchanger 218 is positioned within the thermal region 208, other potions may extend outside of and cross the thermal insulation layer 206 and outer layer 202. For example, the shell 220 may be disposed within the thermal region 208, the water box 221 may be positioned at least partially in the thermal insulation layer 206, and the external coolant tube section 224 may extend out from the water box 221 and penetrate the thermal insulation layer 206 and outer layer 202. As previously discussed, this is advantageous in that it enables the primary heat exchanger 206 to transfer heat to a coolant, but also to enable access to a tube sheet of the primary heat exchanger 206 during maintenance periods. However, given the thermal expansion of the thermal insulation layer 206 and the lack thereof on the outer layer 202, the primary heat exchanger 218 may cause excessive pipe stress of piping connected thereto and/or loss of pressure contained within the reactor enclosure.

To mitigate this challenge, the primary heat exchanger 218 may be equipped with a bellows seal assembly 234 relatively disposed between the thermal insulation layer 206 and radiation shielding layer 202. The bellows seal assembly 234 may include attachment means to connect the shell 220 to the thermal insulation layer 206 and may itself be attached to the radiation shielding layer 202 via additional attachment means. The bellows seal assembly 234 may include a flexible element that encompasses or is wrapped around the external coolant pipe section 224. Upon reaching operational temperatures, the thermal insulation layer expands and increases in diameter, which causes the primary heat exchanger 218 to translate horizontally towards the outer layer 202. The flexible element of the bellow seal assembly is operable to accommodate this horizontal movement by compressing to compensate for the movement. Advantageously, this eliminates or at least reduces stress on piping connections to the primary heat exchanger 218.

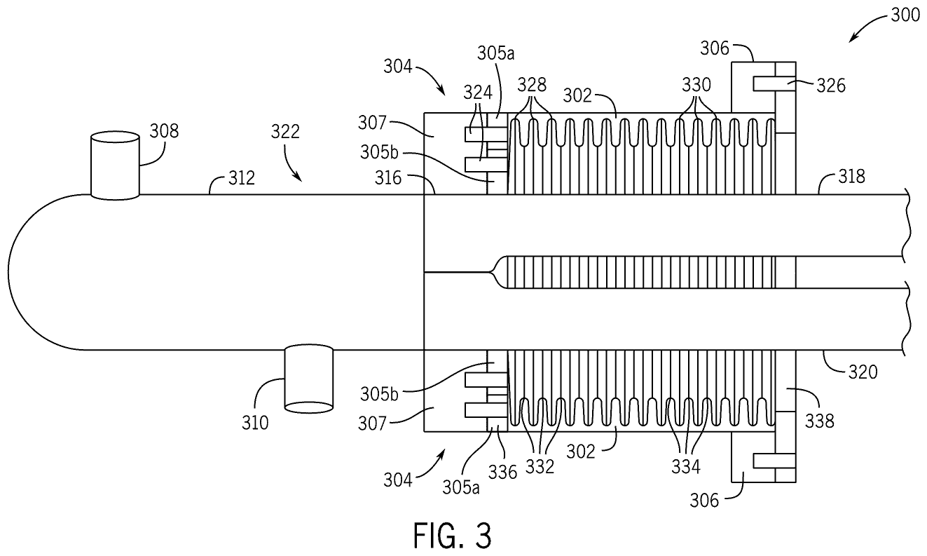

FIG. 3 illustrates an example bellows seal assembly 300. The bellows seal assembly 300 may be substantially analogous to the bellows seal assembly 234 shown and described in relation to FIG. 2. Notwithstanding, FIG. 3 illustrates the bellows seal assembly 300 and additionally illustrates, a first attachment means 304, a second attachment means 306, a flexible element 302, and other components associated therein. The bellows seal assembly 300 may generally include a flexible element 302, a first flange assembly 304, and a second flange 306. In several embodiments, these components are generally operable to allow the primary heat exchanger to translate relative to the radiation shielding layer but remain fixed with the thermal insulation layer. Stated otherwise, the primary heat exchanger moves with the thermal insulation layer upon thermal expansion and such movement is accommodated by compression of the flexible element 302 thereby eliminating piping stress.

The bellow seal assembly 300 may include or be attached to a heat exchanger 322 including a fuel salt inlet 308, a fuel salt outlet 310, a shell 312, a transitional region or water box 316, and an external coolant tube section including an external coolant tube inlet 318 and external coolant tube outlet 320. The example bellows seal assembly 300 may be substantially analogous to that of FIG. 2 in that it is operable to compress to accommodate translation of the primary heat exchanger, advantageously reducing or eliminating pipe stress of the primary fuel loop piping.

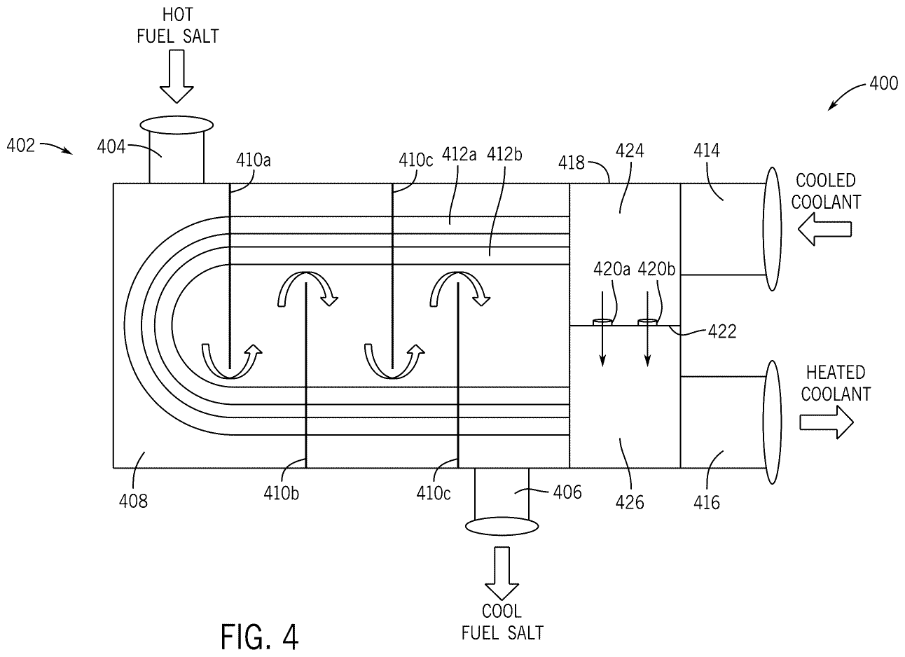

The heat exchanger 322 may be substantially analogous to primary heat exchanger 106 of FIG. 1 or primary heat exchanger 218 of FIG. 2 and be generally operable to transfer heat from a molten salt to a coolant (e.g., a secondary salt). Heat exchanger 322 may be a two-pass U-tube heat exchanger configured to receive fuel salt within the shell 312 (received via inlet 308 and distribute via outlet 310) and coolant within the internal coolant tubes (shown in FIG. 4). Advantageously, the coolant may be disposed within the internal coolant tubes, rather than the shell 312, such that maintenance may be facilitated without exposing the primary fuel salt loop to oxygen or otherwise expose a maintenance worker to fission product gases.

The bellows seal assembly 300 may include attachment means to anchor the flexible element 302 to the shell 312. For example, the bellows seal assembly 300 may include a first flange assembly 304 configured to anchor flexible element 302 to the shell 312 of the primary heat exchanger 322 via a plurality of bolts or screws 324. In several embodiments, the first flange assembly 304 includes an outer flange 305a, an inner flange 305b, and a mating flange 307. Outer flange 305a may be a larger flange (i.e., larger diameter) to inner flange 305b and may concentrically surround inner flange 305b. Outer flange 305a and inner flange 305b may both couple to mating flange 307. Outer flange 305a is configured to anchor flexible element 302 to the heat exchanger 322. Inner flange 305a is configured to anchor the thermal insulation layer and/or the outer flange 305a to the water box 316. Advantageously, this configuration may provide maintenance ease by enabling access to the water box 316 while keeping the heat exchanger 322 anchored to the flexible element 302 and consequently the thermal insulation layer by unbolting inner flange 305b from mating flange 307 while keeping outer flange 350a bolted to mating flange 307. The bellows seal assembly 300 may include additional attachment means to anchor the flexible element 302 to an outer layer of a reactor enclosure (e.g., outer layer 202). For example, bellows seal assembly 300 may include a second flange 306 configured to anchor flexible element 302 to an outer layer of a reactor enclosure (e.g., radiation shielding layer 202) via a plurality of bolts or screws 326. Collectively, the flexible element 302 and attachment means affix the primary heat exchanger to the flexible element, such that as the primary heat exchanger translates due to thermal expansion, such movement is accommodated by flexible element 302 while avoiding undue piping stress.

Flexible element 302 may be generally operable to compress and/or extend upon application of force to the first flange assembly 304, the shell 312, and/or the second flange 306. To facilitate the foregoing, flexible element 302 may include a first plurality of rings 328 interposed with a second plurality of rings 330 between first flange assembly 304 and second flange 306. The first and second plurality of rings 328, 330 are welded to one another along mating longitudinal ends 332, 334, cooperating to form an accordion structure extending from a first flange mating surface 336 (i.e., first flange assembly 304) to a second flange mating surface 338 (i.e., second flange 306). Flexibility of the flexible element 302 may be provided by the accordion structure formed by the connection of the first plurality of rings 328 and second plurality of rings 330, which are configured to cooperatively compress or extend along longitudinal mating ends 332, 334, thereby extending or shortening the length of flexible element 302.

For clarity, FIG. 3 illustrates a cross-sectional view of bellow seal assembly 300 and one of ordinary skill in the art will appreciate that flange assembly 304, flexible element 302, and flange 306 are cylindrical and wrap completely about at least a portion of heat exchanger 322.

In various embodiments, the primary heat exchanges disclosed herein are U-tube type heat exchangers configured to accommodate fuel salt on the shell side and circulate coolant (e.g., a secondary salt) through the U-tubes. FIG. 4 illustrates a fluid flow diagram 400 of fluid through an example U-tube type heat exchanger 402. FIG. 4 serves to illustrate the flow of fluid through the various heat exchangers described herein. For example, such fluid flow may occur within primary heat exchanger 206, 218, 322 of FIGS. 1, 2, and 3 respectively. The various example primary heat exchangers disclosed herein may be a U-tube type heat exchanger and configured to receive hot fuel salt through the shell while circulating a coolant (e.g., a secondary salt) through the internal U-tubes. The U-tube type heat exchanger 402 may be operable to transfer heat from a heated fuel salt to a secondary salt.

To facilitate the foregoing, primary heat exchanger 402 may include a fuel salt inlet 404, fuel salt outlet 406, a shell body 408, and a plurality of baffles 410a, 410b, 410c, 410d. The fuel inlet 404 may receive a fuel salt having an elevated temperature from a reactor vessel (e.g., reactor vessel (212, 102). The fuel outlet 406 may allow the fuel salt to exit the shell body 408 to the drain tank (e.g., drain tank 108, 210) or back to the reactor vessel. The shell body 408 may define an internal volume to house the fuel salt as it circulates from the fuel salt inlet 404 to the fuel salt outlet 406. The plurality of baffles 410a, 410b, 410c, 410d may be obstruction panels disposed within the shell body 408 to direct flow of the fuel salt within the shell body 408 as indicated by the curved arrows of FIG. 4. The plurality of baffles 410a, 410b, 410c, 410d may further support a plurality of U-tubes 412a, 412b. The plurality of U-tubes 412a, 412b may bear a coolant (e.g., a secondary salt) and be disposed within the shell body 408. The plurality of U-tubes 412a, 412b may be fluidly connected to an external coolant inlet 414 and external coolant outlet 416, which are further fluidly connected to an external heat removal system. This configuration enables the fuel salt to enter at an elevated temperature through inlet 404, circulate within shell body 408 and bathe the plurality of U-tubes 412a, 412b facilitating heat transfer thereto and exiting shell body 408 through outlet 406.

In several embodiments, the primary heat exchanger further includes a transitional region or water box 418 interposed between external coolant pipes 414, 416 and the plurality of U-tubes 412a, 412b. Water box 418 serves as a transitional element for coolant to enter and exit the plurality of U-tubes 412a, 412b and includes a partition 422 bisecting the water box 418 into an upper portion 424 and lower portion 426 and separating cooled coolant coming into the water box 418 and heated coolant exiting the water box 418. In several embodiments, water box 418 includes a plurality of weeping passages 420a, 420b disposed on partition 422. Weeping passages 420a, 420b are included to allow coolant to gravitationally drain from the upper portion 424 to the lower portion 426 during maintenance periods, a shutdown event, or the like. As used herein “weeping passages” may be drain passages, weep holes, drain ports, or other fluid egress opening. For example, the weeping passages described herein may be small intentional openings or channels included in components to allow accumulated liquid to escape slowly from said component. In this regard, the weeping passages described herein may be configured to enable controlled drainage of molten salt during non-active flow periods.

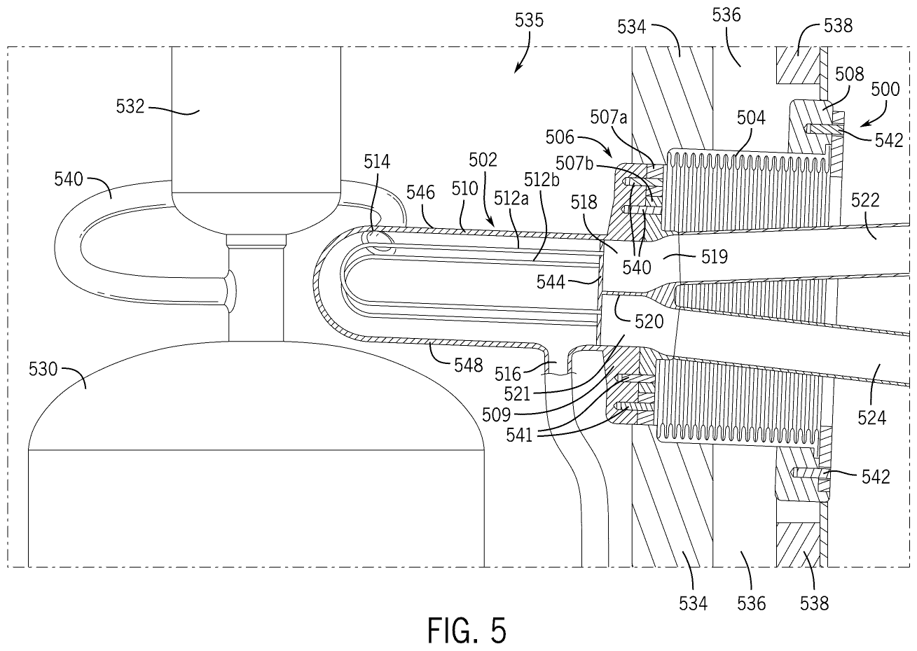

FIG. 5 illustrates an example implementation of the bellows seal assembly 500 in a reactor enclosure. Bellows seal assembly 500 may be substantially analogous to the assemblies described herein (e.g., assembly 300, 234, 124) and include a flexible element 504, a first flange assembly 506, and a second flange 508. Similarly, bellows seal assembly 500 may include or be affixed to a primary heat exchanger 502 of an MSR system (e.g., MSR system 100) including a shell 510, a plurality of internal U-tubes 512a, 512b, a fuel salt inlet 514, a fuel salt outlet 516, a water box 518, a partition 520, and an external coolant pipe region including an external coolant inlet pipe 522 and an external coolant outlet pipe 524.

FIG. 5 highlights how the bellows seal assembly 500 may be installed into a reactor system. The reactor system may include or be disposed within a reactor enclosure and be substantially analogous to that of FIG. 1 and FIG. 2 in that it includes a thermal insulation layer 534 defining a thermal region 535 with salt-bearing components disposed therein. Here, the salt-bearing components may include a reactor vessel 530 configured to facilitate fission reaction of fissile material (e.g., UF₄) within the fuel salt, a reactor access vessel 532 for input of additional fissile material, the primary heat exchanger 502 to facilitate heat transfer, and piping 540 therebetween. The reactor system may be at least partially enclosed by the thermal insulation layer 534 which is further enclosed by a radiation shielding layer 538 with a gap 536 interposed therebetween.

As illustrated in FIG. 5, the primary heat exchanger 502 is coupled to a molten salt loop of an MSR system via piping 540. The primary heat exchanger 502 is therefore configured to receive hot fuel salt from the reactor vessel 530, transfer heat therein to a coolant, and return the fuel salt to the reactor vessel 530 or a drain tank (e.g., drain tank 108, 210). Additionally, the primary heat exchanger 502 penetrates and extends through the thermal insulation layer 534 and the radiation shielding layer 538. In several embodiments, the primary heat exchanger 502 is configured with a drainage slope to facilitate gravitational drainage of molten salt contained therein.

As previously discussed, as the MSR system reaches operational temperatures (i.e., about 600° C.) the thermal insulation layer 534 may expand radially outwards causing the thermal insulation layer 534 to at least partially occupy the gap 536 while the radiation shielding layer 538 may not or only minimally expand. This consequently causes the primary heat exchanger 502 to translate horizontally towards the radiation shielding layer. The bellows seal assembly 500 is configured to accommodate such movement via compression of the flexible element 504.

To facilitate the foregoing, the flexible element 504 may be disposed about the external coolant inlet pipe 522 and the external coolant outlet pipe 524 and may be interposed between the thermal insulation layer 534 and radiation shielding or outer layer 538 such that it occupies space of the gap 536. The bellows seal assembly 500 may comprise a first attachment means and a second attachment means to attach the primary heat exchanger 502 to the thermal insulation layer 534, the flexible element 504 to the thermal insulation layer 534, and the flexible element 504 to the radiation shielding layer 538. For example, the bellows seal assembly 500 may include a first flange assembly 506 disposed within the thermal insulation layer 534 and about the water box 518. In several embodiments, first flange assembly 506 includes an outer flange 507a, an inner flange 507b, and a mating flange 509. Outer flange 507a may be configured to anchor the primary heat exchanger 502 to the flexible element 504 and thermal insulation layer 534 via bolting into mating flange 509. Inner flange 507b may be configured to anchor the water box 518 to the thermal insulation layer 534 via bolting into mating flange 509. In several embodiments, outer flange 507a concentrically surrounds inner flange 507a. Advantageously, by including a first flange assembly 506 including two concentric flanges (507a, 507b) the water box 518 may be accessible (by unbolting inner flange 507b) while keeping the primary heat exchanger 502 anchored (by keeping outer flange 507a bolted). The first flange assembly 506 may attach the primary heat exchanger 502 to the thermal insulation layer 534. Additionally, the first flange assembly 506 attaches the flexible element 504 to the thermal insulation layer 534, thereby anchoring the primary heat exchanger 502 and the flexible element 504 to the thermal insulation layer 534. To facilitate the foregoing, first flange assembly 506 may include a plurality of bolts or screws 541 configured to fasten the first flange assembly 506 in place (i.e., by bolting outer flange 507a and inner flange 507b to mating flange 509). The bellows seal assembly 500 may further include a second flange 508 disposed about and/or within the radiation shielding layer 538 and attaching the flexible element 504 the radiation shielding layer 538 thereby anchoring the primary heat exchanger 502 to the radiation shielding layer 538 through the flexible element 504. To facilitate the foregoing, second flange 508 may include a plurality of bolts or screws 542 configured to fasten the second flange 508 in place (i.e., directly to the radiation shielding layer 538 and/or a mating flange therein). Collectively, the flexible element 504, first flange assembly 506, and second flange 508 are operable to fasten the primary heat exchanger 502 to both the thermal insulation layer 534 and the radiation shielding layer 538. By placing the flexible element 504 between these attachment means, the primary heat exchanger 502 is capable of translating horizontally or radially outwards with the thermal insulation layer 534 towards the radiation shielding layer 538 via compression of the flexible element 504 thereby eliminating or reducing piping stress. Stated otherwise, upon thermal expansion and consequently horizontal translation of the primary heat exchanger 502, the shell 510 translates relative to the radiation shielding layer 538 but remains fixed relative to the thermal insulation layer 534. Additionally, the bellows seal assembly 500 maintains an airtight seal, via first flange 506 and second flange 508, between the thermal insulation layer 534 and radiation shielding layer 538, such that a pressure boundary of the reactor enclosure is maintained (i.e., that within gap 536 and/or thermal region 535).

In several embodiments, the plurality of bolts or screws 541 are configured to screw into first flange assembly 506 towards the thermal region 535 such that the head is accessible from within the flexible element 504 (i.e., facing radially outwards). Similarly, the plurality of bolts or screws 542 are configured to screw into second flange 508 towards the gap 536 such that the head is accessible from outside the radiation shielding layer 538. This configuration is advantageous for maintenance purposes, as it allows an operator to remove the second flange 508 to access the first flange assembly 506. Thereafter, an operator may remove the inner flange 507b to gain access to the water box 518 and a tube sheet 544 therein for maintenance periods without being exposed to the thermal region 535. Further advantageously, by including a first flange assembly 506 including an inner and outer flange 507a, 507b, the outer flange 507a may remain bolted as the inner flange 507b is unbolted. This allows access to the water box 518 while maintaining the pressure boundary of the reactor enclosure (i.e., outer flange 507a keeps the heat exchanger 502 in place and provides a hermetic seal). Additionally, the outer flange 507a allows there to be no or minimal movement between the heat exchanger 502 and flexible element 504 during maintenance periods. In several embodiments, the external coolant inlet pipe 522 and external coolant outlet pipe 524 may be removably fastened to water box 518 to facilitate access therein upon removal of the first flange assembly 506 and second flange 508.

Water box 518 may define a transitional region comprising a first compartment 519, and a second compartment 521 fluidly connected to and interposed between the external coolant pipes 522, 524. In several embodiments, the first compartment 519 defines a fluid path between external coolant pipe inlet 522 and the plurality of internal U-tubes 512a, 512b. Additionally, second compartment 521 defines a fluid path between external coolant pipe outlet 524 and the plurality of internal U-tubes 512a, 521b. First compartment 519 defines a first flow path or entrance path for the coolant salt to enter into the plurality of U-tubes 512a, 512b while the second compartment 521 defines a second flow path or exit path for the coolant salt to exit the plurality of U-tubes 512a, 512b following heat transfer with the fuel salt.

In several embodiments and as illustrated in FIG. 5, the primary heat exchanger 502 is installed at a slight angle, such that the fuel salt may be gravitationally drain for maintenance or during a shutdown event. To facilitate the forgoing, the fuel salt inlet 510 is disposed along a topmost surface 546 of shell 510 while the fuel salt outlet 516 is disposed along a bottommost surface 548 of shell 510. Additionally or alternatively, the primary heat exchanger 502 is installed at a slight angular offset relative to a horizontal axis of the system to encourage fuel salt to drain from the inlet 514 towards the outlet 516. In several embodiments, the angular offset is about 3 degrees; however, in other embodiments the angular offset may be greater or less than 3 degrees. The angular offset is illustrated in FIG. 5 in that a topmost portion of second flange 508 extends slightly outwards from radiation shielding layer 538 while a bottommost portion of second flange 508 is inline with radiation shielding layer 538. Partition 520 may include weeping passages to allow a secondary salt to flow from external coolant pipe inlet 522 to external coolant pipe outlet 524 thereby preventing coolant from remaining in an upper portion of the water box 518.

The bellow seal arrangement may be configured to maintain the pressure boundary of an MSR system while accommodating thermal expansion of the system. To facilitate this, the flexible element includes a first and a second attachment means configured to create an airtight and/or pressure sight seal about the flexible element. Stated otherwise, while the bellows seal assembly penetrates the thermal insulation layer, gap and radiation shielding layer, the pressure within the gap and thermal region is maintained.

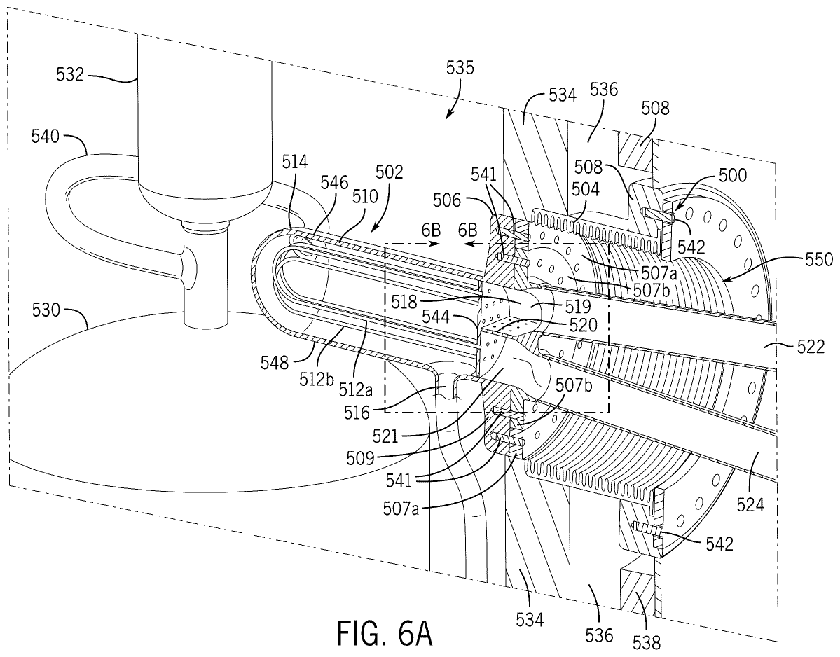

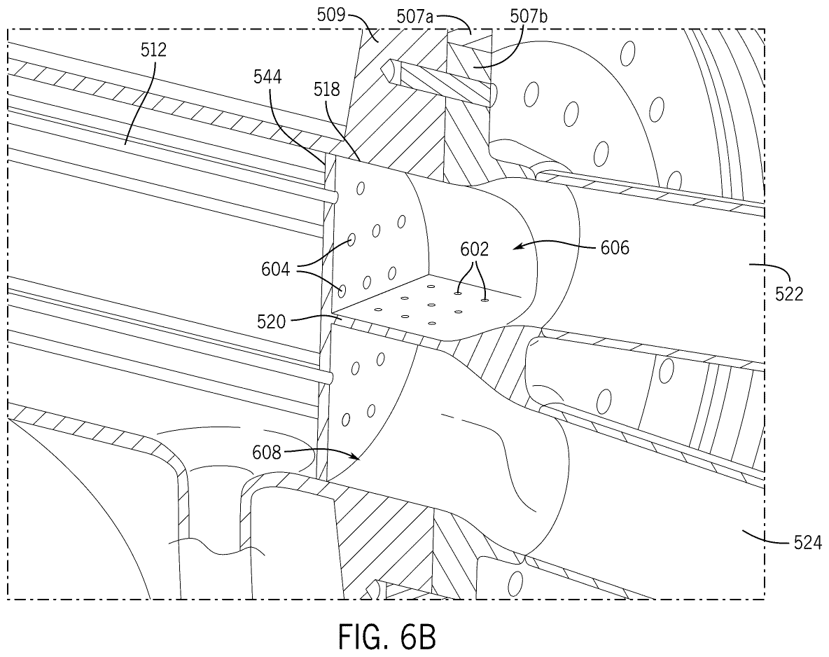

As illustrated in FIG. 6A, flexible element 504 defines a bellows environment 550 to accommodate the external coolant inlet and outlet tubes 522, 524. Additionally, FIG. 6A illustrates an environment of the gap 536 and the thermal region 535. In several embodiments, the bellows seal assembly maintains a pressure of the gap 536 and thermal region 535 by defining airtight connections between the outer layer 538, gap 536, and thermal insulation layer 534. Advantageously, this maintains the pressure boundary of the reactor enclosure, which is not compromised despite the heat exchanger 502 penetrating these regions. In several embodiments, flexible element 504 maintains an airtight and/or pressure tight seal between the plurality of rings via welding connection therebetween. Advantageously, this configuration allows the reactor enclosure to maintain pressure therein despite thermal expansion occurring and despite having various pipes penetrating the reactor enclosure. In several embodiments, the bellows environment 550 is exposed to ambient air.

As previously discussed, the configuration of the bellows seal assembly 550 enables gravitational draining of the fuel salt for maintenance periods or in the event of a shut down by inclusion of weeping passages in the partition 520 of the water box 518. FIG. 6B illustrates a focused view of the example implementation of the bellows seal assembly taken along the 6B-6B line, such that the water box 518 is clearly in view. Water box 518 may be fluidly connected to a tube sheet 544, which serves as an obstruction to cause the coolant to enter the internal U-tubes 512 through a plurality of tube sheet holes 604. For illustrative purposes, not all internal U-tubes are shown. Water box 518 further includes a partition 520 defining and including a plurality of weeping passages 602. In several embodiments, the diameter of each weeping passage 602 is smaller than that of each tube sheet hole 604. Advantageously, this encourages coolant to flow through the tube sheet holes 604, rather than the weeping passages 602 during operation. However, once coolant flow is stopped, due to anticipated maintenance period or shutdown event, the coolant may flow through the weeping passages 602, thereby aiding in gravitational draining of the system.

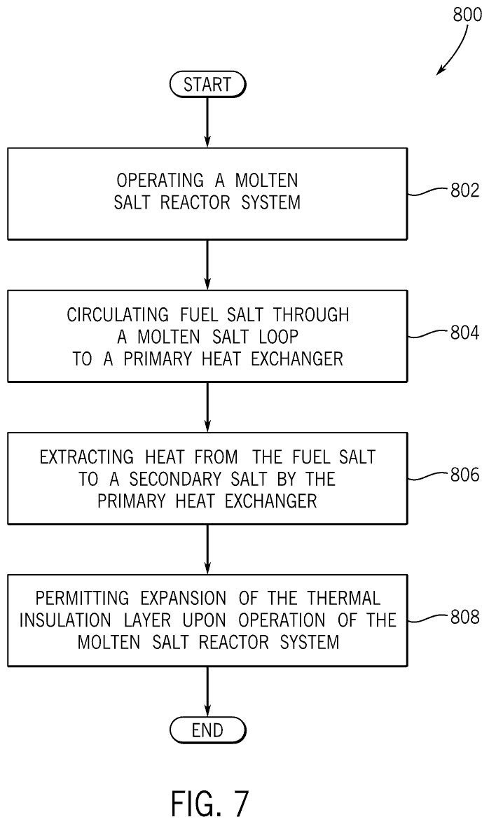

FIG. 7 illustrates a flow diagram of an example method 800 of operating a bellows seal assembly of a primary heat exchanger. At step 802, a molten salt reactor system is operated. For example, and with reference to FIGS. 1 and 2, molten salt reactor system 100 may facilitate fission reaction of fissile material (e.g., UF₄) within a molten fuel salt (e.g., LiF—BeF₂—UF₄) in a reactor vessel 102 containing a reactor core. Fission reaction may cause the molten salt to elevate in temperature. At step 804, the fuel salt may subsequently be circulated to a primary heat exchanger 106 by a reactor pump 104 via a molten salt loop comprising piping between salt bearing components. At step 806, heat from the fuel salt is extracted to a secondary salt via the primary heat exchanger. For example, and with reference to FIGS. 4 and 5, the primary heat exchanger may be a two pass U-tube type heat exchanger 400, 502 with a shell 408, 510 receiving the fuel salt and the internal U-tubes 412a, 412b, 512a, 512b, receiving the coolant. With reference to FIG. 4, the hot fuel salt may enter the shell 408 via inlet 404, may circulate through shell 408 via partitions 410a, 410b, 410c, 410c, such that the fuel salt baths the plurality of internal U-tubes 412a, 412b causing heat transfer before exiting the outlet 406. The coolant may enter the internal U-tubes 412a, 412b, 512a, 512b, via external coolant inlet pipe 414 through water box 418 and may exit the internal U-tubes 412a, 412b, 512a, 512b through water box 418 and out of the heat exchanger 500 via external coolant outlet pipe 416. Notably, in order for the molten salt reactor system to operate, all salt-bearing components must be at an elevated operational temperature (e.g., about 600° C.). In several embodiments, this is facilitated by forming a thermal region about the salt-bearing components by a thermal insulation layer. However, this thermal insulation layer is expected to expand as operational temperatures are reached, which may cause piping stress on any penetrating components (e.g., primary heat exchanger).

At step 808, the thermal insulation layer is permitted to expand upon operation of the molten salt reactor system. For example, and with reference to FIGS. 1, 2, and 5, a primary heat exchanger bellows seal assembly 124, 234, 300, 500 may be employed to accommodate thermal expansion of thermal insulation layer 206, 534. In several embodiments, the primary heat exchanger of the molten salt reactor system penetrates both the thermal insulation layer and the radiation shielding or outer layer. Upon thermal expansion, the primary heat exchanger translates with the radiation shielding layer. Such translation is accommodated by a flexible element, for example flexible element 302, 504, of the bellows seal assembly to ensure undue piping stress is avoided. The flexible element may compress as the thermal insulation layer and primary heat exchanger are pushed towards the outer layer. This may be facilitated by the attachment means of the bellows seal assembly, for example first flange assembly 304, 506, and second flange 306, 508, which anchors the primary heat exchanger and flexible element to the thermal insulation layer (i.e., first flange assembly 304, 306) and anchors the flexible element to the radiation shielding layer (i.e., second flange 306, 508).

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A system comprising:
a reactor enclosure comprising a thermal insulation layer and an outer layer;
the thermal insulation layer contained within the outer layer and defining a thermal region;
the outer layer defining a pressure boundary;
a molten salt reactor vessel including a reactor core configured to facilitate fission reaction disposed within the thermal region;
a primary heat exchanger comprising a shell defining a shell volume and a coolant tube assembly comprising an internal coolant pipe section fluidly coupled to an external coolant pipe section;
wherein the shell is disposed within the thermal region;
wherein the tube assembly is disposed, relative to the shell, with the internal coolant pipe section within the shell volume and the external coolant pipe section extending therefrom, exterior to the thermal insulation region and through the pressure boundary;
a bellows seal assembly disposed about the external coolant pipe section of the primary heat exchanger and connected to each of the thermal insulation layer and the outer layer; and
wherein the bellows seal is configured to accommodate thermal expansion of the thermal insulation layer by compressing toward the outer layer while maintaining the connection between the thermal insulation layer and the outer layer.

2. The system of claim 1, wherein the bellows seal assembly is configured to maintain the pressure boundary upon compression.

3. The system of claim 1, wherein the bellows seal assembly is configured to allow the shell to translate with the thermal insulation layer upon thermal expansion via compression of a flexible element.

4. The system of claim 3, wherein the bellows seal comprises a first flange and a second flange;
wherein the first flange anchors the shell to the thermal insulation layer;
wherein the first flange connects the flexible element to the thermal insulation layer; and
wherein the second flange connects the flexible element to the outer layer.

5. The system of claim 1, wherein the shell volume is fluidically coupled to a drain tank and the molten salt reactor vessel; and
wherein the shell volume is configured to receive an elevated-temperature flow of molten salt from a fuel salt inlet, and upon heat removal therein, deliver a reduced-temperature flow of molten salt from a fuel salt outlet to the drain tank or the molten salt reactor vessel.

6. The system of claim 5, wherein the fuel salt inlet is disposed along a topmost surface of the shell;
wherein the fuel salt outlet is disposed along a bottommost surface;
wherein the topmost and bottommost surface are angularly offset relative to a horizontal axis of the system; and
wherein the angular offset causes gravitational draining of the fuel salt disposed within the shell volume out of the fuel salt outlet.

7. The system of claim 1, wherein the primary heat exchanger further comprises a transition region comprising a first compartment and a second compartment fluidly connecting and interposed between the external coolant pipe section to the internal coolant pipe section;
wherein the first compartment defines a first flow path between a first external coolant pipe of the external coolant pipe sections and an entrance of a first internal coolant loop of the internal coolant pipe sections; and
wherein the second compartment defines a second flow path between a return of the first internal coolant loop of the internal coolant pipe sections and a second external coolant pipe of the external coolant pipe sections.

8. The system of claim 7, wherein the transition region comprises a partition separating the first and second compartment from one another.

9. The system of claim 8, wherein the partition defines at least one weeping passage having a diameter smaller than a diameter of each of a plurality of passages of a tube sheet and fluidly coupling the first compartment and the second compartment.

10. The system of claim 1, wherein the bellows seal assembly defines a passage for the external coolant pipe section; and wherein the passage comprises ambient air.

11. The system of claim 1, wherein the thermal insulation layer is arranged within the reactor enclosure at an inward offset from the outer layer about the periphery of the thermal insulation layer.

12. They system of claim 10, wherein the thermal region is about 600° C.; and wherein the periphery of the thermal insulation layer is about 100° C.

13. A system comprising:
a primary heat exchanger comprising a shell defining a shell volume and a tube assembly comprising an internal coolant pipe section fluidly coupled to an external coolant pipe section;
wherein the shell is fluidly coupled to a fuel salt loop of a nuclear reactor system;
a bellows seal assembly disposed about the external coolant pipe section such that a coolant inlet and a coolant outlet are surrounded by the bellows seal;
wherein the bellows seal assembly is at least partially interposed between a thermal insulation layer and an outer layer of a reactor enclosure of the nuclear reactor system;
wherein the insulation layer is disposed within the outer layer;
wherein the insulation layer defines a thermal region;
wherein the outer layer defines a pressure boundary; and
the bellows seal assembly operable to accommodate thermal expansion of the thermal insulation layer via compression of the bellows seal thereby enabling horizontal translation of the primary heat exchanger.

14. The system of claim 13, wherein the bellows seal is operable to maintain the pressure boundary upon horizontal translation of the primary heat exchanger.

15. The system of claim 13, wherein the bellows seal assembly comprises a first flange anchoring the primary heat exchanger to the thermal insulation layer and a flexible element to the thermal insulation layer; and
wherein the bellows seal assembly comprises a second flange anchoring the flexible element to the outer layer.

16. The system of claim 15, wherein the first flange, the second flange, and the flexible element are collectively operable, upon horizontal translation of the primary heat exchanger, to cause the shell of the primary heat exchanger to translate relative to the outer layer and remain fixed relative to the thermal insulation layer.

17. The system of claim 13, wherein the primary heat exchanger is fluidly coupled, via the fuel salt loop, to a drain tank or a reactor vessel of the nuclear reactor system; and
wherein the shell volume is configured to receive an elevated-temperature flow of molten salt from a fuel salt inlet, and upon heat removal therein, deliver a reduced-temperature flow of molten salt from a fuel salt outlet to the drain tank or the reactor vessel.

18. The system of claim 17, wherein the fuel salt inlet is disposed along a topmost surface of the shell;
wherein the fuel salt outlet is disposed along a bottommost surface of the shell;
wherein the topmost and bottommost surfaces are angularly offset relative to a horizontal axis of the system; and
wherein the angular offset causes gravitational draining of the fuel salt disposed within the shell volume out of the fuel salt outlet.

19. The system of claim 13, where the primary heat exchanger further comprises a transition region comprising a first compartment and a second compartment;
wherein the first compartment defines a first flow path between a first external coolant pipe of the external coolant pipe section and an entrance of a first internal coolant loop of the internal coolant pipe section;
wherein the second compartment defines a second flow path between a return of the first internal coolant loop of the internal coolant pipe section and a second external coolant pipe of the external coolant pipe section;
wherein the transition region comprises a partition separating the first and second compartment from one another; and
wherein the partition defines at least one weeping passage fluidly coupling the first compartment and the second compartment.

20. A method of operating a bellows seal assembly of a primary heat exchanger comprising:
operating a molten salt reactor system enclosed within a reactor enclosure comprising a thermal insulation layer and an outer layer thereby causing a temperature of a fuel salt to increase;
wherein the molten salt reactor system comprises a molten salt loop coupled to a primary heat exchanger;
wherein the primary heat exchanger comprises a shell affixed to the thermal insulation layer fluidly coupled to external secondary salt piping affixed to the outer layer;
wherein the bellows seal assembly is disposed about the external secondary salt piping;
circulating the fuel salt through the molten salt loop to the primary heat exchanger;
extracting heat from the fuel salt to a secondary salt by the primary heat exchanger;
permitting expansion of the thermal insulation layer upon operation of the molten salt reactor system while maintaining connection between the shell and the thermal insulation layer via compression of the bellows seal assembly.
